(19) United States
(12) Patent Application Publication
(10) Pub. No.: US 2017/0226329 A1
(43) Pub. Date: Aug. 10, 2017

(54) ETHYLCELLULOSE DISPERSION AND POWDER

(71) Applicant: Dow Global Technologies LLC, Midland, MI (US)

(72) Inventors: David L. Malotky, Midland, MI (US); Shari L. Workentine, Midland, MI (US); True L. Rogers, Midland, MI (US); Stacey L. Dean, Litchfield, OH (US); Liang Chen, Midland, MI (US); Matthew J. Crimmins, Saint Charles, MI (US)

(73) Assignee: Dow Global Technologies LLC, Midland, MI (US)

(21) Appl. No.: 15/502,804

(22) PCT Filed: Aug. 12, 2015
(86) PCT No.: PCT/US15/44799

§ 371 Date: Feb. 9, 2017

Related U.S. Application Data
(60) Provisional application No. 62/037,881, filed on Aug. 15, 2014.

(51) Int. Cl. C08L 1/28; C08J 3/18; C09D 101/26; C08J 3/12

(52) U.S. Cl. CPC C08L 1/28; C08J 3/122; C08J 3/18; C09D 101/26; C08J 2301/28

(57) ABSTRACT

Provided is an aqueous composition having pH of 8 or higher and comprising (i) a solid phase comprising dispersed particles that comprise ethylcellulose polymer, (ii) fatty acid, wherein 25 mole % to 100 mole % of said fatty acid is in ionic form, (iii) 0% to 0.1% colloid stabilizer, by weight based on the dry weight of said ethylcellulose polymer, (iv) 0% to 7% plasticizer, by weight based on the dry weight of said ethylcellulose polymer, and (v) one or more cations of an alkali metal or an alkaline earth, wherein the equivalent ratio of said cations to said fatty acid is 0.1:1 to 2:1. Also provided are a method of spray drying an aqueous composition and a powder composition.

It is often desirable to make films that contain ethylcellulose polymer. Such films are useful, for example, as coatings applied to other films or to beads. In some cases, a collection of beads contains a drug, and each of those beads is then coated with a film that contains ethylcellulose polymer. The film that contains ethylcellulose polymer can provide controlled release of the drug when the beads are placed in an aqueous environment such as that which can be found in the human body. It is also desirable that the film have good mechanical properties such as high tensile strength, high tensile elongation, and surface smoothness. In the past, a common method of making such a film was to contact the beads with a solution in which ethylcellulose polymer was dissolved in an organic solvent. Organic solvents are undesirable because of environmental and health effects. It is desired to provide an aqueous coating composition that contains ethylcellulose polymer and that is capable of producing high quality films. One desirable form of such an aqueous coating composition is an aqueous ethylcellulose polymer dispersion, which is a form in which particles of ethylcellulose polymer are dispersed in a continuous aqueous medium.

Important issues are the storage and transportation of ethylcellulose polymer. For example, if the aqueous dispersion were made in one location, then stored, then transported to a new location, and then stored again at the new location, the methods of storing and transporting would be required to accommodate a relatively large volume of water as well as the ethylcellulose polymer. It is desirable to provide a water-dispersible powder, which is a powder that contains ethylcellulose polymer and that, when brought into contact with water, forms an aqueous ethylcellulose polymer dispersion. Then, the storage and transportation operations could be performed on a powder without the need for storing and transporting water. U.S. Pat. No. 6,169,130 describes redispersible powders.

It is further desired to provide an aqueous composition that could be dried, for example by spray drying, to form a water-dispersible powder. It is desirable that redispersible powders have low amounts of colloid stabilizer and/or plasticizer.

The following is a statement of the invention.

A first aspect of the present invention is an aqueous composition having pH of 8 or higher and comprising
(i) a solid phase comprising dispersed particles that comprise an amount of ethylcellulose polymer,
(ii) 0.5% to 7% fatty acid, by weight based on the total dry weight of the solid phase, wherein 25 mole % to 100 mole % of said fatty acid is in ionic form,
(iii) 0% to 0.1% colloid stabilizer, by weight based on the dry weight of said ethylcellulose polymer,
(iv) 0% to 7% plasticizer, by weight based on the dry weight of said ethylcellulose polymer, and
(v) one or more cations of an alkali metal or of an alkaline earth, wherein the equivalent ratio of said cations to said fatty acid is 0.1:1 to 2:1.

A second aspect of the present invention is a method of making a powder comprising spray drying the aqueous composition of the first aspect.

A third aspect of the present invention is a powder composition comprising
(a) 0% to 2% water by weight based on the weight of said powder composition,
(b) particles that comprise
   (I) an amount of ethylcellulose polymer,
   (II) 0.5% to 7% fatty acid, by weight based on the weight of said powder composition, wherein 25 mole % to 100 mole % of said fatty acid is in the form of an alkali metal or alkaline earth salt,
   (III) 0% to 0.1% colloid stabilizer, by weight based on the dry weight of said ethylcellulose polymer,
   (IV) 0% to 7% plasticizer, by weight based on the dry weight of said ethylcellulose polymer.

The following is a detailed description of the invention.

As used herein, the following terms have the designated definitions, unless the context clearly indicates otherwise.

As used herein, an aqueous composition has 30% or more water by weight based on the weight of the composition. As used herein, a dispersion is a composition that contains a continuous medium that is liquid at 25° C. and contains discrete particles (herein called the “dispersed particles”) of a substance that are distributed throughout the continuous liquid medium. As used herein, an aqueous dispersion is an aqueous composition that is a dispersion in which the continuous liquid medium contains 50% or more water by weight based on the weight of the continuous liquid medium. Substances that are dissolved in the continuous liquid medium are considered herein to be part of the continuous liquid medium. The collection of all the dispersed particles is known herein as the “solid phase” of the dispersion. As used herein, the terms “dispersion” and “emulsion” are synonymous.

As used herein, a dispersant is a composition that improves the ability of the dispersed particles in a dispersion to become dispersed (that is, distributed throughout the continuous liquid medium) and/or to remain dispersed upon exposure to storage at 25° C., exposure to temperatures higher than 25° C., exposure to shear, or a combination thereof.

As used herein, the “solids content” of an aqueous composition is the amount of material that remains when water and compounds having boiling point of 150° C. or less have been removed, by weight based on the total weight of the aqueous composition.

As used herein, the term high internal phase emulsion refers to an emulsion having equal to or greater than 74 wt % dispersed phase based on the total weight of the emulsion.

Ethylcellulose polymer, as used herein, means a derivative of cellulose in which some of the hydroxyl groups on the repeating glucose units are converted into ethyl ether groups. The number of ethyl ether groups can vary. The USP monograph requirement for ethyl ether content is from 44 to 51%.

As used herein, the viscosity of an ethylcellulose polymer is the viscosity of a 5 weight percent solution of that ethylcellulose polymer in a solvent, based on the weight of the solution. The solvent is a mixture of 80% toluene and 20% ethanol by weight based on the weight of the solvent. The viscosity of the solution is measured at 25° C. in an Ubbelohde viscometer.

As used herein, a fatty acid is a compound having a carboxyl group and a fatty group. A fatty group is a linear or branched chain of carbon atoms connected to each other that contains 8 or more carbon atoms. A hydrocarbon fatty group contains only carbon and hydrogen atoms.

When it is said herein that a composition contains “little or no” amount of an ingredient, it is meant that the amount of that ingredient is either zero or is 0.1% or less by weight based on the dry weight of ethylcellulose polymer. When it is said herein that a composition contains “little or no” amount of a list of ingredients, it is meant that the sum of the amounts of those ingredients is either zero or is 0.1% or less by weight based on the dry weight of ethylcellulose polymer. These definitions of “little or no” apply to any composition that contains ethylcellulose polymer, whether the composition is an aqueous composition or is not an aqueous composition.

As used herein, a plasticizer is a compound that is not a fatty acid, that is miscible with ethylcellulose polymer, and that, when mixed with ethylcellulose polymer, reduces the glass transition temperature of that ethylcellulose polymer.

As used herein, a colloid stabilizer is a polymer that has number-average molecular weight of 500 or higher and that is water soluble. A polymer is considered herein to be water soluble if 2 grams or more of the polymer will dissolve in 100 grams of water at 25° C.

When it is stated herein that a ratio is X:1 or larger, it is meant that the ratio is Y:1, where Y is equal to or larger than X. For example, if it is stated that a certain ratio is 0.2:1 or larger, the ratio may be 0.2:1 or 0.5:1 or 100:1, but the ratio is not 0.1:1 or 0.02:1. Similarly, when is stated herein that a ratio is W:1 or smaller, it is meant that the ratio is Z:1, where Z is equal to or smaller than W. For example, if it is stated that a certain ratio is 5:1 or smaller, the ratio may be 5:1 or 4:1 or 0.1:1, but the ratio is not 6:1 or 10:1.

As used herein, a fugitive base is a basic compound. When an aqueous composition that contains a fugitive base is dried, when the remaining dried composition has 5% or less water by weight based on the weight of the dried composition, the amount of the fugitive base that remains in the dried aqueous composition is 5% or less by weight based on the weight of fugitive base present in the aqueous composition prior to the drying process. A non-fugitive base does not depart from an aqueous composition when the aqueous composition is subjected to a drying process. That is, when an aqueous composition that contains a non-fugitive base is dried, when the remaining dried composition has 5% or less water by weight based on the weight of the dried composition, the amount of the non-fugitive base that remains in the dried aqueous composition is 80% or more by weight based on the weight of non-fugitive base present in the aqueous composition prior to the drying process.

Any ethylcellulose polymer may be used in the present invention. The ethyl ether content of the ethylcellulose polymer is 44% or more; preferably 47% or more; more preferably 48% or more. The ethyl ether content of the ethylcellulose polymer is 51% or less; preferably 50% or less.

The ethylcellulose polymer preferably has viscosity of 2 mPa-s or higher; more preferably 5 mPa-s or higher; more preferably 12 mPa-s or higher; more preferably 16 mPa-s or higher. The ethylcellulose polymer preferably has viscosity of 120 mPa-s or lower; more preferably 100 mPa-s or lower; more preferably 80 mPa-s or lower; more preferably 60 mPa-s or lower; more preferably 40 mPa-s or lower; more preferably 30 mPa-s or lower.

Commercially available forms of ethylcellulose polymer which may be used in the invention include, for example, those available under the name ETHOCEL™, from The Dow Chemical Company. The ethylcellulose polymers used in the inventive examples are commercially available from The Dow Chemical Company as ETHOCEL™ Standard 10, ETHOCEL™ Standard 20, or ETHOCEL™ Standard 100 with ethyl ether content from 48.0 to 49.5%. Other commercially available ethylcellulose polymers useful in embodiments of the invention include certain grades of AQUALON™ ETHYLCELLULOSE, available from Ashland, Inc., and certain grades of ASHACEL™ ethylcellulose polymers, available from Asha Cellulose Pvt.Ltd.

Optionally, any non-water-soluble cellulose derivative polymer may be used in addition to the ethylcellulose polymer.

The present invention involves an aqueous dispersion. Preferably, the continuous liquid medium contains water in the amount, by weight based on the weight of the continuous liquid medium, of 60% or more; more preferably 70% or more; more preferably 80% or more; more preferably 90% or more.

Preferably, the dispersed particles in the aqueous dispersion contain ethylcellulose polymer in an amount, by weight based on the total dry weight of the solid phase, of 60% or more; more preferably 70% or more; more preferably 80% or more; more preferably 85% or more. Preferably, the dispersed particles in the aqueous dispersion contain ethylcellulose polymer in an amount, by weight based on the total dry weight of the solid phase, of 99% or less; more preferably 98% or less.

The composition of the present invention contains one or more fatty acids, which may be saturated or unsaturated. More preferred are unsaturated fatty acids. The fatty group of the fatty acid may be linear or branched; preferred is linear. The fatty group of the fatty acid may be a hydrocarbon fatty group or may have one or more substituents other than hydrogen or carbon; preferred are hydrocarbon fatty groups. Among unsaturated fatty acids, preferred are myristoleic acid, palmitoleic acid, sapienic acid, oleic acid, linoleic acid, and arachidonic acid. Among saturated fatty acids, preferred are caprylic acid, capric acid, lauric acid, palmitic acid, myristic acid, stearic acid, and arachidic acid. Preferably the dispersant contains oleic acid. Preferably, the fatty acid acts as a dispersant in the aqueous composition, when the pH of the aqueous composition is sufficiently high that 50 mole % of the fatty acid has carboxyl group that is in the form of a carboxylate anion.

Among embodiments in which oleic acid is used, “pure” and “technical grade oleic acid” can be employed as oleic acid. A pure oleic acid is understood as meaning a composition which contains more than 98 wt. % of oleic acid. A “technical grade oleic acid” is understood as meaning a composition which contains oleic acid to the extent of 98 wt. % or less. Such a technical grade oleic acid contains e.g. oleic acid in a range of from 60 to 75 wt. %, linoleic acid in a range of from 5 to 20 wt. % and stearic acid in a range of from 0 to 5 wt. %, based on the total weight of the technical grade oleic acid, the sum of the percentages by weight being 100. Technical grade oleic acid can be obtained from animal fats, for example beef tallow. A technical grade oleic acid with a higher content of oleic acid can likewise be employed, e.g. with 80 to 95 wt. %, preferably 85 to 95 wt. % and furthermore preferably 90 to 95 wt. %, in each case based on the total composition. A technical grade oleic acid with 96 to 98 wt. % of oleic acid, based on the total fatty acid composition, is very particularly preferred. Another technical grade oleic acid with approx. 80 to 90 wt. % of oleic acid, 2 to 10 wt. % of linoleic acid, 2 to 6 wt. % of stearic acid and 2 to 6 wt. % of palmitic acid, based on the total weight of the other technical grade oleic acid, the sum of the percentages by weight being 100. Such another technical grade oleic acid is marketed e.g. as “high oleic” sunflower oil or HO sunflower oil.

The amount of fatty acid is preferably, by weight based on the total dry weight of the solid phase, 0.5% or more; more preferably 1% or more; more preferably 2% or more. The amount of fatty acid is preferably, by weight based on the total dry weight of the solid phase, 7% or less; more preferably 6% or less.

The aqueous composition of the present invention contains cations of one or more alkali metal or of one or more alkaline earth or a mixture thereof. Preferably the aqueous composition of the present invention contains cations of one or more alkali metals; more preferably cations of sodium or potassium or a mixture thereof.

The amount of cations of alkali metal(s) and/or alkaline earth(s) is characterized by the ratio (the “equivalent ratio”) of the sum of the total equivalents of all cations of alkali metals and cations of alkaline earths in the aqueous composition to the total equivalents of all carboxyl groups attached to fatty acid molecules in the aqueous composition. Preferably, that equivalent ratio is 0.5:1 or higher; more preferably 0.75:1 or higher; more preferably 0.9:1 or higher. Preferably, that equivalent ratio is 2:1 or lower; more preferably 1.75 or lower; more preferably 1.5:1 or lower.

Preferably, the aqueous composition of the present invention contains either no ammonium ion or else contains an amount of ammonium ion such that the ratio of equivalents of ammonium ion to the total equivalents of all carboxyl groups attached to fatty acid molecules in the aqueous composition is 0.01:1 or lower.

In some compositions other than the present invention that contain ethylcellulose polymer, relatively large amounts of a colloid stabilizer are present. Commonly used colloid stabilizers include, for example, polyvinyl alcohol (PVA), poly(N-vinyl pyrrolidone), and water-soluble polymers that are derivatives of cellulose. In contrast to those other compositions, the composition of the present invention preferably contains little or PVA. More preferably, the composition of the present invention contains little or no PVA or poly(N-vinyl pyrrolidone). More preferably, the composition of the present invention contains little or no PVA, poly(N-vinyl pyrrolidone), or water soluble polymers that are derivatives of cellulose. More preferably, the composition of the present invention contains little or no colloid stabilizer.

In some compositions other than the present invention that contain ethylcellulose polymer, relatively large amounts of a plasticizer are present. Typical plasticizers are organic esters having molecular weight of 200 or greater and polyethylene glycols having molecular weight of 200 or greater. Commonly used plasticizers include, for example, triethyl citrate (TEC), dibutyl sebacate (DBS), diethyl phthalate, dibutyl phthalate, polyethylene glycol of molecular weight of 200 or higher, and triglycerides of molecular weight of 200 or higher.

In contrast to those other compositions, the composition of the present invention preferably either contains no plasticizer or else contains an amount of plasticizer, by weight based on the dry weight of ethylcellulose polymer, of 7% or less; more preferably 3% or less; more preferably 1% or less; more preferably 0.3% or less; more preferably 0.1% or less. Preferably, the composition of the present invention contains little or no triethyl citrate (TEC) or dibutyl sebacate (DBS). More preferably, the composition of the present invention contains little or no TEC, DBS, diethyl phthalate, dibutyl phthalate, polyethylene glycol of molecular weight of 200 or higher, or triglyceride of molecular weight of 200 or higher. More preferably, the composition of the present invention contains little or no polyethylene glycol having molecular weight of 200 or greater or organic ester having molecular weight of 200 or greater. More preferably, the composition of the present invention contains little or no plasticizer.

The preferred process for making the aqueous composition of the present invention is as follows. The process comprises feeding ethylcellulose polymer and a dispersant into a melt and mix zone of an extruder wherein the ethylcellulose polymer and dispersant (including one or more fatty acids) are heated and mixed together to form a melt; conveying the melt to an emulsification zone of the extruder in which the temperature and pressure are controlled; feeding a base and water into the emulsification zone wherein the melt is dispersed to form a high internal phase emulsion; conveying the emulsion to a dilution and cooling zone of the extruder; and feeding water into the dilution and cooling zone to dilute the high internal phase emulsion thereby forming an aqueous dispersion. The general process conditions and equipment which may be used to perform the process are disclosed in U.S. Pat. Nos. 5,539,021 and 5,756,659.

The extruder may have several zones, including a mixing and conveying zone, an emulsification zone, and a dilution and cooling zone. Steam pressure at the feed end, which is contained in the mixing and conveying zone, is controlled by placing kneading blocks and blister elements before the emulsification zone to create a melt seal. Steam pressure at the outlet, which is contained in the dilution and cooling zone, is controlled by using a back-pressure regulator. The base polymer, i.e., ethylcellulose, is fed into the feed throat of the extruder and flows into the mixing and conveying zone. The liquid dispersant(s) (including one or more fatty acids) are also fed into the mixing and conveying zone and may be fed separately or jointly. If the dispersant is a solid, it may be optionally fed into the extruder through the extruder feed throat. The polymer phase, which includes the base polymer and dispersant, is melted in the mixing and conveying zone and conveyed down the barrel of the extruder to the emulsification zone.

In the emulsification zone, the polymer phase is combined with an initial amount of water and a base, to create a high internal phase emulsion. The emulsion is then conveyed down the extruder and combined with more water in the dilution and cooling zone to form an aqueous dispersion having less than or equal to 60% wt. solids, e.g. dispersed polymer phase.

Preferably, the base that is fed into the emulsification zone is a non-fugitive base. Preferred bases are aqueous solutions of KOH, NaOH, or a mixture thereof. Preferably the ratio of the moles per minute of base being fed to the extruder to the moles per minute of fatty acid being fed to the extruder is 0.5:1 or higher; more preferably 0.9:1 or higher. Preferably the ratio of the moles per minute of base being fed to the extruder to the moles per minute of fatty acid being fed to the extruder is 2:1 or lower; more preferably 1.75:1 or lower.

The aqueous composition of the present invention preferably has pH of 12 or lower; more preferably 11 or lower; more preferably 10 or lower. The aqueous composition of the present invention has pH or 8 or higher.

The dispersed particles in the aqueous composition of the present invention preferably have volume-average particle diameter of 1.1 micrometers or less; more preferably 1.0 micrometer or less; more preferably 0.9 micrometers or less; more preferably 0.8 micrometers or less. The dispersed particles in the aqueous composition of the present invention preferably have volume-average particle diameter of 80 nm or greater; more preferably 90 nm or greater. Particle size was measured using laser diffraction. A suitable instrument is a COULTER™ LS-230 or COULTER™ LS-13-320 particle size analyzer (Beckman Coulter Corporation).

The aqueous composition of the present invention preferably has a solids content, by weight based on the weight of the aqueous composition, of 5% or more; more preferably 10% or more; more preferably 15% or more; more preferably 20% or more. The aqueous composition of the present invention preferably has a solids content, by weight based on the weight of the aqueous composition, of 55% or less; more preferably 50% or less; more preferably 45% or less; more preferably 40% or less; more preferably 35% or less.

The viscosity of the aqueous composition of the present invention is measured at 25° C. using a Brookfield RV-II viscometer with an RV2 or RV3 spindle spinning at 50 rpm. The spindle is chosen to give the torque signal nearest to the center of the viscometer's torque range. Preferably the viscosity of the aqueous composition is 100 mPa-s or lower; more preferably 80 mPa-s or lower; more preferably 60 mPa-s or lower; more preferably 40 mPa-s or lower; more preferably 30 mPa-s or lower. Preferably the viscosity of the aqueous composition is 1 mPa-s or higher.

Also contemplated are embodiments of the aqueous composition of the present invention that are herein called “mixed base” embodiments. In a mixed base embodiment, the equivalent ratio of cations of a non-fugitive base to carboxyl groups on the fatty acid is 0.5:1 to 1:1. In a mixed-base embodiment, the aqueous composition also contains one or more fugitive base. In a mixed-base embodiment, the preferred fugitive base is ammonia. In a mixed-base embodiment, the preferred equivalent ratio of cations of a fugitive base to carboxyl groups on the fatty acid is 0.5:1 to 1:1.

It is contemplated that a coating made from an aqueous composition in which the fatty acid was neutralized only with fugitive base would be a very hydrophobic coating. It is also contemplated that a coating made from an aqueous composition in which the fatty acid was neutralized only with non-fugitive base would be a much less hydrophobic coating. It is further contemplated that a coating made from an aqueous composition in which the fatty acid was partially neutralized with fugitive base and partially neutralized with non-fugitive base would have intermediate hydrophobicity.

While the present invention is not limited by any theory, it is contemplated that, when the coating is used as a barrier coating to control the release rate of an active ingredient into an aqueous environment, the hydrophobicity has an effect on the release rate. It is contemplated that very hydrophobic coatings will have the slowest release rate; that coatings having intermediate hydrophobicity will have intermediate release rate; and that coatings being the least hydrophobic will have the highest release rate. Therefore, it is contemplated that by varying the relative amounts of fugitive base and non-fugitive base, it would be possible adjust the hydrophobicity of the coating and thus the release rate of the coating.

One method of making such an aqueous composition would be to provide a first aqueous composition in which the fatty acid was neutralized entirely with fugitive base, to provide a second aqueous composition in which the fatty acid was neutralized entirely with non-fugitive base, and to blend the two aqueous compositions.

A preferred use for the aqueous composition of the present invention is to produce a powder by removing the water from the aqueous composition. The preferred method of removing the water is by spray drying. In the process of spray drying, the aqueous composition is passed through one or more atomizers or nozzles to produce droplets of the aqueous composition. Either during or after the formation of the droplets of the aqueous composition, the droplets are brought into contact with a heated gas, preferably air. Contact with the heated gas removes most or all of the water from the droplets of the aqueous composition.

When an aqueous composition of the present invention is dried to produce a powder, the resulting powder preferably has an amount of water that is, by weight based on the weight of the powder, 0% to 2%; more preferably 0% to 1%; more preferably 0% to 0.5%.

It is contemplated that the solid phase of the aqueous composition of the present invention becomes the powder of the dried composition. The ingredients and amounts described herein above regarding the contents of the aqueous composition of the present invention apply as well to the powder. For example, because it is stated herein above that the aqueous composition of the present invention preferably contains ethylcellulose polymer in an amount, by weight based on the total dry weight of the solid phase, of 60% or more, it is to be understood that the powder preferably contains ethylcellulose polymer in an amount, by weight based on the total dry weight of the powder, of 60% or more.

Each particle in the powder is expected to be an agglomerate of many of the particles that were dispersed in the aqueous medium. The weight-average particle diameter in the powder is expected to be 10 micrometers to 500 micrometers.

Cations of alkali metal(s) and/or alkaline earth(s) are present in the powder. The preferred compositions and equivalent ratios are the same in the powder as those described herein above for the aqueous composition.

It is contemplated that some or all of the cations of alkali metal(s) and/or cations of alkaline earth(s) and some or all of the one or more fatty acids are present in the powder in the form of one or more salts. For example, if sodium is present in the powder and oleic acid is also present, some or all of the sodium and some or all of the oleic acid is present as the sodium salt of oleic acid.

Preferably, 25 mole % to 100 mole % of all the fatty acid is in the form of an alkali metal or alkaline earth salt; more preferably 50 mole % to 100 mole %.

Preferably, the powder of the present invention is water dispersible. That is, when the powder is brought into contact with water of pH 7.5 or lower, at 25° C., at a weight ratio of 27 or fewer parts of powder to 100 parts of water, and the resulting mixture is agitated (for example, by stirring), the mixture will form an aqueous dispersion. The dispersed particles will contain ethylcellulose polymer. It is contemplated that the dispersed particles will have the same composition and particle size distribution as the aqueous composition of the present invention had prior to the drying process that formed the powder.

It is contemplated that an aqueous dispersion made from the powder of the present invention (that is, a “re-dispersed” dispersion) will be useful in the same ways that a dispersion made directly by extrusion (that is, an “original” dispersion) would be useful.

For example, a preferred use of such a dispersion is in forming a pharmaceutical coating or a food coating; more preferred is a pharmaceutical coating; more preferred is a modified-release pharmaceutical coating. A preferred method of making a modified-release pharmaceutical coating is to provide a plurality of particles, where each particle contains a drug and apply a coating of the film on the particles. Preferred particles either are pure or nearly pure particles of the drug itself or are polymer particles that contain the drug within a polymeric matrix. Also contemplated are particles of a non-drug substance that are coated with the drug and particles that are mixed with a drug by spheronization. Preferred particles have weight-average diameter of 100 μm to 1 mm. Preferably, the aqueous dispersion coats each particle and, when dried, leaves a film that covers or nearly covers each particle.

When an aqueous dispersion is used to make a coating on a plurality of particles, it is often desirable to add a plasticizer to the dispersion prior to bringing the aqueous dispersion into contact with the plurality of particles. Common plasticizers are triethyl citrate (TEC) and dibutyl sebacate (DBS). When a plasticizer is added to a dispersion immediately prior to contact with a plurality of particles, the dispersion may be either an original dispersion or a re-dispersed dispersion.

When a composition forms a coating on a plurality of particles, it is desired that the coating have good film properties, such as relatively high values of Young's modulus, tensile strength, and maximum elongation. It is contemplated that these properties may be tested by making a free film (that is, a film that is not attached to any substrate) and testing the tensile properties of the free film. It is contemplated that films that have acceptable properties as free films will also have acceptable properties when formed into coatings on particles.

The following are examples of the present invention.

### Example 1

### Preparation of Aqueous Dispersion

A dispersion was prepared using a Berstorff™ ZE25 twin screw extruder rotating at 450 rpm, with 25 mm screw diameter and length to diameter ratio of 36. Materials were as follows:
Ethocel™ STD20 ethylcellulose (Dow Chemical Company)
Oleic Acid
Potassium Hydroxide (KOH), 30% solution by weight in water

The ethylcellulose was delivered using a volumetric feeder equipped with a large tube and large open helix. The polymer phase was then melted and conveyed down the extruder barrel to an emulsification zone where it is combined with an initial amount of water and a base to create a high internal phase emulsion. The emulsion was then conveyed down the extruder barrel to the diluting and cooling zone. The initial water, base, and dilution water are each supplied separately to the extruder with Isco™ syringe pumps. The oleic acid was delivered using an Isco™ syringe pump, plumbed into the melt zone. The barrels were initially set to 145° C. The front end heaters on the exit piping and back pressure regulator remained on during the run and set to 180° C. The initial water heater was turned on to deliver at approximately 140° C. The dilution water heater was set to 120° C. The relative feed rates of oleic acid and KOH were adjusted to provide an equivalent ratio of 1:1. The extruder exit temperature was 140° C.

The extruder was run with feed rates adjusted to give a mass ratio of ethylcellulose to oleic acid of 95:5, to produce Example 1-1. The feed rates were then adjusted to give a mass ratio of ethylcellulose to oleic acid of 97:3, to produce Example 1-2.

The results were as follows:

| Property | Example 1-1 | | Example 1-2 | |
|---|---|---|---|---|
| Weight ratio of | 95:5 | | 97:3 | |
| ethylcellulose:oleic acid | | | | |
| pH | 9.59 | | 9.68 | |
| % Solids⁽¹⁾ | 28.77% | | 29.47% | |
| Viscosity⁽²⁾ | 20 | mPa-s | 18 | mPa-s |
| Vmean⁽³⁾ | 0.129 | μm | 0.584 | μm |

(1) amount of solid material in the dispersion, by weight based on the total weight of the dispersion, determined using a microwave solids analyzer or an infrared solids analyzer. One analyzer used was the OHAUS™ MB45 infrared moisture analyzer (available from Ohaus Corporation).

(2) Brookfield RV viscometer, spindle #3, 50 rpm, 25° C.

(3) volume-average particle diameter, determined by using a COULTER™ LS-230 or COULTER™ LS-13-320 particle size analyzer (Beckman Coulter Corporation).

### Comparative Example C2

### Preparation of Aqueous Dispersion Neutralized with Ammonia

An aqueous dispersion of ethylcellulose was prepared as in Example 1, with the following differences:
Neutralizing base: aqueous solution of 28% wt ammonia (as NH₃)
Weight ratio of ethylcellulose to oleic acid: 89.1:10.9
Equivalent ratio of ammonia to oleic acid: 1.4:1

The results were as follows:

| Property | Comp. Ex. C2 | |
|---|---|---|
| Weight ratio of | 89.1:10.9 | |
| ethylcellulose:oleic acid | | |
| pH | 9.11 | |
| % Solids⁽¹⁾ | 26.64 | |
| Viscosity⁽²⁾ | 22 | mPa-s |
| Vmean⁽³⁾ | 0.211 | μm |

⁽¹⁾as in Example 1
⁽²⁾Brookfield RV, number 2 spindle, 50 rpm
⁽³⁾as in Example 1

### Comparative Example C3

### Preparation of Aqueous Dispersions with Colloid Stabilizer

The aqueous dispersion of Comparative Example C3 was modified by the addition of colloid stabilizer, either polyvinyl alcohol (PVA) or polyvinyl pyrrolidone (PVP). Colloid stabilizer in 10 wt % aqueous solution was added into the ethylcellulose dispersion under agitation. The PVA used was MOWIOL™ 488 PVA from Kuraray Co, having average molecular weight of 31 kg/mol. The PVP used was purchased from Sigma Aldrich, the average molecular weight was 10 kg/mol. The amounts used were as follows, by weight based on the sum of the dry weights of ethylcellulose polymer and oleic acid:

| Comparative | Colloid | Amount of |
|---|---|---|
| Example | Stabilizer | colloid stabilizer |
| C3-1 | PVA | 8% by weight |
| C3-2 | PVP | 8% by weight |

### Example 4

### Spray Drying and Re-Dispersing of Aqueous Dispersions

Aqueous dispersions were spray dried to produce dry powder. Spray drying was conducted on a Mobile Minor™ Spray Dryer under nitrogen with a two-fluid nozzle atomizer. The dry powder was then tested for re-dispersibility as follows: The redispersibility of the spray-dried powders was evaluated based on the comparison of the particle size of the spray-dried powder dispersed in water and the original particle size of the starting dispersion. The spray-dried powder was dispersed into deionized water at 1% solids and vortexed for 30 seconds twice. The particle size of the redispersion was then measured by a Coulter LS 13 320 Laser Light Diffraction Particle Size analyzer. The desired particle size of ethylcellulose polymer dispersion is below 1 μm. The redispersibility “yield” is defined as the volume percentage of particles below 1 μm in the redispersion. For instance, if the redispersion shows 20% of particles below 1 μm by volume, the redispersibility yield of this powder is 20%.

Moisture in the dry powder is the amount of water by weight based on the weight of the powder. “na” means not analyzed. For Example 1, the Vmean was measured (by the methods described above) of the dispersion produced by re-dispersing the dry powder in deionized water. The results were as follows. The notation “<20%” means “less than 20%.”

| | | Comp. Ex. | Comp. Ex. | Comp. Ex |
|---|---|---|---|---|
| | Ex. 1 | C3-1 | C3-2 | C3-3 |
| weight ratio of | 95:5 | 89.1:10.9 | 89.1:10.9 | 89.1:10.9 |
| ethylcellulose:oleic acid | | | | |
| Colloid Stabilizer | none | PVA | PVP | none |
| Base | KOH | ammonia | ammonia | ammonia |
| Spray Drier inlet | 135° C. | 140° C. | 120° C. | 135° C. |
| Spray Drier outlet | 50° C. | 39° C. | 47° C. | 42° C. |
| Moisture in powder | 1.75% | 1.60% | 1.14% | 1.24% |
| redispersibility yield | 100% | <20% | <20% | <20% |
| Vmean of redispersed | 129 nm | 10.2 μm | 6.8 μm | 8.2 μm |
| powder | | | | |

Comparative Examples C3-1, C3-2, and C3-3 used ammonia as the base and showed poor redispersibility in deionized water. All three showed very low redispersibility yield, and all three showed redispersed Vmean over 50 times the Vmean of Example 1.

### Comparative Example C5

### Varied Amounts of Oleic Acid When Ammonia is Used

Comparative Example C5-1 was a repetition of Comparative Example C2. As in Comparative Example C2, ammonia was used as the base. After collecting sample dispersion under the conditions of Comparative Example C2 (to produce Comparative Example C5-1), the extrusion was continued with a ratio of ethylcellulose to oleic acid changing in steps to reduce the relative amount of oleic acid. Vmean was measured as above. The results were as follows:

| | Weight Ratio of | | |
|---|---|---|---|
| Example | ethylcellulose:oleic acid | Vmean | Observation |
| C5-1 | 89.1:10.9 | 0.6 μm | |
| C5-2 | 90.2:9.8 | approximately 1.1 μm | |
| C5-3 | 91.4:8.6 | approximately 10 μm | |
| C5-4 | 92.5:7.5 | 50 μm | gritty |

Comparative Example C5 demonstrates that, when ammonia is used as the base, more than 7.5% oleic acid is required to produce a useful dispersion. In order to be useful, dispersion particle size should be significantly less than 1 μm.

### Example 6

### Film Properties

To each aqueous dispersion, triethyl citrate, a plasticizer, was added to give 27% by weight plasticizer based on the total solids weight of the aqueous dispersion. Then, films were cast from aqueous dispersions as follows: Films were cast at thickness of 0.5 mm (20 mil) wet onto a precleaned glass plate using a BYK four sided draw down bar. Films were covered and transferred to an oven set to 60° C. to cure for 2 hr. Films were then taken to a controlled humidity room (55% relative humidity, 22° C.) for at least 12 hrs for the moisture content of the films to equilibrate.

Aqueous dispersions were either “original” or “re-disp”, defined as follows:
original: aqueous dispersion produced by the extruder, then mixed with plasticizer, then cast as a film.
re-disp: aqueous dispersion produced by the extruder, then spray dried, then redispersed in water to give 27% solids content, then mixed with plasticizer, then cast as a film.

Examples C6-1 and C6-2 are Comparative Examples. Aqueous dispersions were as follows:

| Example | Dispersion | EC:OA⁽⁴⁾ | base | Type | Vmean⁽⁵⁾ | |
|---|---|---|---|---|---|---|
| C6-1 | C6-1a⁽⁶⁾ | 89.1:10.9 | ammonia | original | 0.208 | μm |
| C6-2 | C6-1a⁽⁶⁾ | 89.1:10.9 | ammonia | re-disp | 10.2 | μm⁽⁷⁾ |
| 6-3 | Ex. 1 | 95:5 | KOH | original | 0.136 | μm |
| 6-4 | Ex. 1 | 95:5 | KOH | re-disp | 0.138 | μm |

⁽⁴⁾weight ratio of ethylcellulose to oleic acid
⁽⁵⁾measured after addition of plasticizer
⁽⁶⁾repetition of Comparative Example C2
⁽⁷⁾redispersibility yield = <20%

Films were removed from the substrate prior to tensile measurements. Tensile measurements were taken on 10 or more sample strips cut from at least three different films. The thickness of each sample strip was determined by measuring along three points using a Mitutoya Digimatic Indicator and averaging. The Young's modulus was measured by fitting the points in the linear area of the stress/strain curve. The maximum stress (reported as Tensile Strength) and strain at break (reported as % Elongation) were manually determined by placing the cursor over the curve and reading the value. Results were as follows:

| Example | Young's Modulus | Maximum Elongation | Tensile Strength |
|---|---|---|---|
| C6-1 | 23 MPa | 39% | 1.3 MPa |
| C6-2 | 39 MPa | 18% | 1.4 MPa |
| 6-3 | 78 MPa | 7.3% | 3.0 MPa |
| 6-4 | 60 MPa | 9.6% | 2.9 MPa |

Comparative Example C6-2 showed maximum elongation less than half of the maximum elongation of Comparative Example C6-1. This result shows that, when a dispersion was made with ammonia, spray dried, and then redispersed, the resulting dispersion cannot make as good a film as a film made from a dispersion that had not been spray dried and re-dispersed. In contrast, Examples 6-3 and 6-4 had similar properties to each other, and that result shows that the process of spray drying and redispersing did not degrade the ability of the inventive dispersion to form a good film.

1. An aqueous composition having pH of 8 or higher and comprising
(i) a solid phase comprising dispersed particles that comprise an amount of ethylcellulose polymer,
(ii) 0.5% to 7% fatty acid, by weight based on the total dry weight of the solid phase, wherein 25 mole % to 100 mole % of said fatty acid is in ionic form,
(iii) 0% to 0.1% colloid stabilizer, by weight based on the dry weight of said ethylcellulose polymer,
(iv) 0% to 7% plasticizer, by weight based on the dry weight of said ethylcellulose polymer, and
(v) one or more cations of an alkali metal or of an alkaline earth, wherein the equivalent ratio of said cations to said fatty acid is 0.1:1 to 2:1.

2. The aqueous composition of claim 1, wherein the amount of said ethylcellulose polymer is 45% to 90% by weight based on the dry weight of said solid phase.

3. The aqueous composition of claim 1, wherein said ethylcellulose powder has viscosity of 16-30 mPa-s, wherein the viscosity of said ethylcellulose powder is defined as the viscosity of a 5 weight percent solution of said ethylcellulose polymer in a solvent, based on the weight of the solution, wherein the solvent is a mixture of 80% toluene and 20% ethanol by weight based on the weight of the solvent.

4. The aqueous composition of claim 1, wherein the equivalent ratio of said cations to said fatty acid is 0.5:1 to 2:1.

5. The aqueous composition of claim 1,
wherein the equivalent ratio of said cations to said fatty acid is 0.2:1 to 1:1
wherein said aqueous composition additionally comprises one or more fugitive bases, and wherein the equivalent ratio of cations of said fugitive base to said fatty acid is 0.2:1 to 1:1.

6. A method of making a powder comprising spray drying the aqueous composition of claim 1.

7. A powder composition comprising
(a) 0% to 2% water by weight based on the weight of said powder composition,
(b) particles that comprise
(I) an amount of ethylcellulose polymer,
(II) 0.5% to 7% fatty acid, by weight based on the weight of said powder composition, wherein 25 mole % to 100 mole % of said fatty acid is in the form of an alkali metal or alkaline earth salt,
(III) 0% to 0.1% colloid stabilizer, by weight based on the dry weight of said ethylcellulose polymer,
(IV) 0% to 7% plasticizer, by weight based on the dry weight of said ethylcellulose polymer.

8. The powder of claim 7, wherein the amount of said ethylcellulose polymer is 45% to 90% by weight based on the dry weight of said powder.

9. The powder composition of claim 7, wherein said ethylcellulose powder has viscosity of 16-30 mPa-s, wherein the viscosity of said ethylcellulose powder is defined as the viscosity of a 5 weight percent solution of said ethylcellulose polymer in a solvent, based on the weight of the solution, wherein the solvent is a mixture of 80% toluene and 20% ethanol by weight based on the weight of the solvent.
